(19) United States
(12) Patent Application Publication
(10) Pub. No.: US 2015/0004483 A1
(43) Pub. Date: Jan. 1, 2015

(54) METHOD FOR JUDGING AMOUNT OF IMPURITIES IN SOLVENT FOR ELECTROLYTE LIQUID, METHOD FOR PRODUCING ELECTROLYTE LIQUID USING SAME, AND ELECTROLYTE LIQUID

(71) Applicant: Central Glass Co., Ltd., Yamaguchi (JP)

(72) Inventors: Keita NAKAHARA, Ube (JP); Natsuya NISHIMURA, Ube (JP)

(21) Appl. No.: 14/312,773

(22) Filed: Jun. 24, 2014

(30) Foreign Application Priority Data
Jun. 26, 2013 (JP) 2013-133721
May 12, 2014 (JP) 2014-098727

(51) Int. Cl. H01M 10/0525; G01N 21/94; H01M 10/0568

(52) U.S. Cl. CPC H01M 10/0525; H01M 10/0568; G01N 21/94
USPC 429/199; 429/188; 436/164

(57) ABSTRACT

Provided are a method for judging the amount of impurities in a solvent for an electrolyte liquid to be used in a non-aqueous electrolyte liquid battery, that enables judging, more easily than conventionally, the amount in which several types of impurities causing degradation of battery performance is contained in the solvent; a method for producing an electrolyte liquid using this judging method; and an electrolyte liquid. The judging method includes: obtaining a reaction solution by adding a Lewis acid to the solvent; measuring the Hazen value of the reaction solution; and judging whether the value is no more than a predetermined threshold. The producing method includes mixing, with an electrolytic salt, the solvent for which the Hazen value has been judged to be no more than the threshold by the judging method. The electrolyte liquid contains: the solvent with the Hazen value as judged above; and an electrolytic salt.

### CROSS REFERENCE TO RELATED APPLICATIONS

The present invention claims priority under 35 U.S.C. §119 to Japanese Patent Application No. 2013-133721, filed on 26 Jun. 2013, and Japanese Patent Application No. 2014-098727, filed on 12 May 2014, the entire contents of which are incorporated herein by reference.

### BACKGROUND OF THE INVENTION

1. Field of the Invention

The present invention relates to a method for judging the amount of impurities in a solvent for an electrolyte liquid to be used in a non-aqueous electrolyte liquid battery, a method for producing an electrolyte liquid using this judging method, and an electrolyte liquid.

2. Related Art

Upon carrying out the production of lithium secondary batteries and lithium ion batteries, the degradation in performance due to impurities carried by the electrolyte liquid has become a problem. It is often the case that almost all of the impurities in the electrolyte liquid causing the battery performance to degrade are carried from the solvent which is a raw material of the above-mentioned electrolyte liquid; therefore, it is important to manage whether the amount of the impurities in such a solvent is at a level adversely affecting the battery performance. Impurities consist of not a single specific compound, but rather a plurality of compounds. Thus far, the impurities in the solvent are found one-by-one, and qualitative analysis and/or quantitative analysis of the impurities therein is performed, while confirming the influence on battery performance by the impurities therein. The analysis method and purification method of the solvent are established in relation to individual impurities, thereby carrying out management of impurities.

For example, Patent Document 1 describes a method of measuring the amount of phosphorus-containing impurities contained in a lithium secondary battery organic electrolyte liquid from ³¹P-NMR spectra. Patent Document 2 gives moisture and hydrogen fluoride as trace impurities in the electrolyte liquid that are known to adversely affect the performance of batteries, and describes measuring the moisture content by Karl Fischer's method and measuring hydrogen fluoride by way of acid-base titration with bromthymol blue as the indicator. Patent Document 3 describes specific chlorine-containing chain-like ethers having unsaturated bonds being included as impurities in non-aqueous electrolyte liquid containing carbonate having unsaturated bonds, and using gas chromatography in order to detect this chlorine-containing chain-like ether.

[Patent Document 1] Japanese Unexamined Patent Application, Publication No. H10-144344

[Patent Document 2] Japanese Unexamined Patent Application, Publication No. 2000-299126

[Patent Document 3] Japanese Unexamined Patent Application, Publication No. 2010-282760

### SUMMARY OF THE INVENTION

However, conventional methods for judging the amount of impurities in a solvent for an electrolyte liquid to be used in a non-aqueous electrolyte liquid battery have complicated operations required in analysis, and thus may require a long time in judgement. Moreover, there is a possibility of the impurities mixed into the electrolyte liquid from the solvent varying according to the solvent production lot. Conventionally, there is no quantitative method common to all impurities, and it has been difficult to comprehensively judge the amount of impurities in a solvent for an electrolyte liquid to be used in non-aqueous electrolyte liquid batteries. As a result, there is also a possibility of a performance degradation of uncertain origin (cycle characteristic tending to decline, internal resistance tending to increase, obtained electrolyte liquid tending to become colored, etc.) being induced.

The present invention has been made taking consideration of the current situation, and has an object of providing a method for judging the amount of impurities in a solvent for an electrolyte liquid to be used in a non-aqueous electrolyte liquid battery, that enable judging, more easily than conventionally, the amount in which several types of impurities causing degradation of battery performance is contained in the solvent for an electrolyte liquid; a method for producing an electrolyte liquid using this judging method, and an electrolyte liquid.

The present inventors thoroughly researched in order to achieve the above-mentioned objects. As a result, it was found that it is possible to judge whether the amount of impurities in a solvent for an electrolyte liquid is at a level adversely affecting battery performance by simply evaluating the hue of the solvent for an electrolyte liquid upon adding a Lewis acid to the solvent and allowing to react, without making any extensive operations such as qualitative analysis or quantitative analysis of individual impurities in the solvent for an electrolyte liquid, thereby arriving at completion of the present invention. More specifically, the present invention provides the following.

A first aspect of the present invention is a method for judging the amount of impurities in a solvent for an electrolyte liquid to be used in a non-aqueous electrolyte liquid battery, the method including: a reacting step of obtaining a reaction solution by adding a Lewis acid to the solvent for an electrolyte liquid; a Hazen value measuring step of measuring the Hazen value of the reaction solution; and a judging step of judging whether the Hazen value is no more than a predetermined threshold.

A second aspect of the present invention is a method for producing an electrolyte liquid, including a mixing step of mixing, with an electrolytic salt, the solvent for an electrolyte liquid for which the Hazen value has been judged to be no more than the threshold by the above-mentioned judging method.

A third aspect of the present invention is an electrolyte liquid containing: the solvent for an electrolyte liquid for which the Hazen value has been judged to be no more than the threshold by the above-mentioned judging method; and an electrolytic salt.

According to the present invention, it is possible to provide a method for judging the amount of impurities in a solvent for an electrolyte liquid to be used in a non-aqueous electrolyte liquid battery, that enable judging, more easily than conventionally, the amount in which several types of impurities causing degradation of battery performance is contained in the solvent for an electrolyte liquid, a method for producing an electrolyte liquid using this judging method, and an electrolyte liquid.

### DETAILED DESCRIPTION OF THE INVENTION

### Method for Judging Amount of Impurities in Solvent for Electrolyte Liquid to be Used in Non-Aqueous Electrolyte Liquid Battery

The method for judging according to the present invention is a method for judging the amount of impurities in a solvent for an electrolyte liquid to be used in a non-aqueous electrolyte liquid battery, and includes a reacting step of obtaining a reaction solution by adding a Lewis acid to the above-mentioned solvent for an electrolyte liquid, a Hazen value measuring step of measuring the Hazen value of the above-mentioned reaction solution, and a judging step of judging whether the above-mentioned Hazen value is no more than a predetermined threshold.

The Lewis acid added to the solvent for an electrolyte liquid reacts with the impurities in the solvent for an electrolyte liquid, whereby this solvent for an electrolyte liquid becomes colored. Since the degree of coloring reflects the amount of the impurities, it is possible to judge the amount of the impurities in the solvent for an electrolyte liquid by measuring the degree as the Hazen value and comparing with a predetermined threshold.

### Reacting Step

In the reacting step, the reaction solution is obtained by adding a Lewis acid to the solvent for an electrolyte liquid.

The solvent for an electrolyte liquid is not particularly limited so long as being used in non-aqueous electrolyte liquid batteries, and examples thereof include cyclic carbonates such as ethylene carbonate (hereinafter also referred to as “EC”), propylene carbonate (hereinafter also referred to as “PC”) and butylene carbonate; chain carbonates such as ethylmethyl carbonate (hereinafter also referred to as “EMC”), dimethyl carbonate (hereinafter also referred to as “DMC”) and diethyl carbonate (hereinafter also referred to as “DEC”); cyclic esters such as y-butyrolactone and γ-valerolactone; chain esters such as methyl acetate and methyl propionate; cyclic ethers such as tetrahydrofuran, 2-methyltetrahydrofuran and dioxane; chain ethers such as dimethoxyethane and diethyl ether; sulfur-containing non-aqueous organic solvents such as dimethyl sulfoxide and sulfolane; etc. In addition, vinylene carbonate, vinylethylene carbonate, fluoroethylene carbonate, etc. can also be used as the above-mentioned solvent. As the solvent for an electrolyte liquid, one type may be used alone, or two or more types may be used in accordance with the application by mixing them in any combination and proportions.

The Lewis acid is not particularly limited so long as being a substance accepting electron pairs (electron pair acceptor), and BX₃ (provided that X is a halogen atom such as a fluorine atom, chlorine atom, bromine atom or iodine atom; the same below), AlX₃, NF₃, PF₅, H⁺, Li⁺, Na⁺, SO₃, CO₂ and the like can be exemplified. In addition, it is also possible to add the Lewis acid using a complex containing the above-mentioned Lewis acid (for example, a diethyl ether complex of BF₃, etc.). In this case, the substance receiving the electron pair (electron pair acceptor) is the Lewis acid (in the case of a diethyl ether complex of BF₃, BF₃ is the Lewis acid.).

Among the above, due to acquisition and handling being easy, it is preferable to add Lewis acid using PF₅, BF₃, a diethyl ether complex of BF₃, or the like.

The added amount of the Lewis acid is not particularly limited; however, it is preferably 1 to 20% by mass relative to the solvent for an electrolyte liquid. If the added amount of the Lewis acid is within this range, the coloring reaction of the solvent for an electrolyte liquid by the addition of the Lewis acid tends to progress at a sufficient rate, and the repeatability of the obtained Hazen value tends to be high. A more preferable added amount of the Lewis acid is 2 to 5% by mass relative to the solvent for an electrolyte liquid.

The reaction temperature in the reacting step is not particularly limited; however, it is preferably 50 to 55° C. If the above-mentioned reaction temperature is within this range, since the time required in coloring of the solvent for an electrolyte liquid will not be too long, it is preferable from the aspect of efficiency, and since the volatilization amount of the solvent for an electrolyte liquid will not be too much, it is preferable from a safety aspect.

The reaction time in the reacting step is not particularly limited; however, it is preferably at least 1 hour. If the above-mentioned reaction time is at least 1 hour, the reaction will tend to sufficiently progress, and the Hazen value measured in the Hazen value measuring step described later will tend to be stable; therefore, suitable judgement will tend to be carried out in the judging step. The above-mentioned reaction time is more preferably 1 to 2 hours.

In order to exclude the influences of hydrolysis by moisture in the atmosphere and oxidation from oxygen in the atmosphere, the reaction in the reacting step is preferably carried out under an inert atmosphere.

### Hazen Value Measuring Step

In the Hazen value measuring step, the Hazen value of the above-mentioned reaction solution obtained in the above-mentioned reacting step is measured. The Hazen value is measured in compliance with JIS K 0071-1.

### Judging Step

In the judging step, it is judged whether the above-mentioned Hazen value measured in the above-mentioned Hazen value measuring step is no more than a predetermined threshold. In the case of the above-mentioned Hazen value being no more than the above-mentioned threshold, it is judged that the amount of the impurities in the solvent for an electrolyte liquid is small.

The above-mentioned threshold is a value of a boundary as to whether an electrolyte liquid prepared using the solvent for an electrolyte liquid or a non-aqueous electrolyte liquid battery prepared using this electrolyte liquid satisfies desired characteristics. For example, the above-mentioned threshold is chosen so that, if the above-mentioned Hazen value is no more than the predetermined threshold, a cycle characteristic, internal resistance characteristic and/or coloring resistance are evaluated as being favorable.

More specifically, the thresholds when individually using EC, EMC, DEC, DMC or PC as the solvent for an electrolyte liquid are as follows.

EC: 200, EMC: 60, DEC: 60, DMC: 80, PC: 160

In addition, the threshold when using a mixed solvent obtained by mixing these solvents as the solvent for an electrolyte liquid can be calculated by weighting the volume fraction of each solvent in the above-mentioned solvent for an electrolyte liquid, and taking the weighted average of thresholds when using each solvent individually. Therefore, for a solvent for an electrolyte liquid consisting of EC, EMC, DEC, DMC, PC or two or more of these, the threshold can be expressed by the formula below.

200×a+60×b+60×c+80×d+160×e

In the formula, a is the volume fraction of EC, b is the volume fraction of EMC, c is the volume fraction of DEC, d is the volume fraction of DMC, and e is the volume fraction of PC.

### Method for Producing Electrolyte Liquid

The method for producing an electrolyte liquid according to the present invention includes a mixing step of mixing, with electrolytic salt, the above-mentioned solvent for an electrolyte liquid for which the above-mentioned Hazen value has been judged to be no more than the above-mentioned threshold according to the above-mentioned judging method. The mixing of the solvent for an electrolyte liquid and electrolytic salt can be performed according to a known method.

The electrolytic salt is not particularly limited so long as being one used in non-aqueous electrolyte liquid batteries and, for example, lithium salt can be used. As specific examples of the lithium salt, LiPF₆, LiBF₄, LiClO₄, LiAsF₆, LiSbF₆, LiCF₃SO₃, LiN(SO₂CF₃)₂, LiN(SO₂C₂F₅) ₂, LiN(SO₂CF₃)(SO₂C₄F₉), LiC(SO₂CF₃)₃, LiPF₃(C₃F₇)₃, LiB(CF₃)₄, LiBF₃(C₂F₅) and the like can be exemplified. As the electrolytic salt, one type may be used alone, or two or more types may be used by mixing them in any combination and proportions in accordance with the application. Thereamong, when considering the energy density as a battery, output characteristics, life span, etc., LiPF₆, LiBF₄, LiN(SO₂CF₃)₂ and LiN(SO₂C₂F₅)₂ are preferable, and LiPF₆ is particularly preferable.

The concentration of electrolytic salt is not particularly limited; however, it is preferably a range with the lower limit being at least 0.5 mol/L, preferably at least 0.7 mol/L, and more preferably at least 0.9 mol/L, and the upper limit being no more than 2.5 mol/L, preferably no more than 2.2 mol/L, and more preferably no more than 2.0 mol/L. If the concentration of electrolytic salt is 0.5 to 2.5 mol/L, the viscosity of the electrolyte liquid will not rise easily, and the ion conductivity will not decline easily; therefore, the cycle characteristic of the non-aqueous electrolyte liquid battery will not decline easily.

With the method for producing an electrolyte liquid according to the present invention, so long as not harming the effects of the present invention, a step of adding other additives commonly used in electrolyte liquid at any proportion may be included prior to mixing the solvent for an electrolyte liquid with the electrolytic salt, simultaneously with mixing the solvent for an electrolyte liquid with electrolytic salt, or after mixing the solvent for an electrolyte liquid with electrolytic salt. As specific examples of other additives, compounds having an overcharge preventing effect, anode film forming effect and/or cathode protecting effect such as cyclohexylbenzene, biphenyl, t-butylbenzene, vinylene carbonate, vinylethylene carbonate, difluoroanisole, fluoroethylene carbonate, propane sultone, and dimethylvinylene carbonate can be exemplified. In addition, it is also possible to use by making the electrolyte liquid a pseudo-solid by a gelating agent or cross-linking polymer as in the case of being used in a non-aqueous electrolyte liquid battery called a lithium polymer battery.

### Electrolyte Liquid

The electrolyte liquid according to the present invention contains the above-mentioned solvent for an electrolyte liquid for which the Hazen value has been judged to be no more than the above-mentioned threshold according to the above-mentioned judging method, and the electrolytic salt. The electrolyte liquid according to the present invention may contain other additives commonly used in electrolyte liquids. The solvent for an electrolyte liquid, electrolytic salt and other additives are as described above. The electrolyte liquid according to the present invention, for example, can be obtained by the method for producing an electrolyte liquid according to the present invention.

### EXAMPLES

Hereinafter, the present invention will be explained specifically by way of test examples; however, the present invention is not to be limited to these test examples. It should be noted that, according to the methods shown below, quality evaluations were performed for the electrolyte liquid obtained from the raw solvent used in the present test examples, and for the cell of a lithium ion battery prepared using this electrolyte liquid.

A generally acquired solvent (EC, EMC, DMC, DEC or PC) was distilled in advance, the initial distillate was used as the solvent in which various impurities are contained in relative abundance, and the main distillate was used as solvent in which impurities are relatively few. The method and conditions for distillation are as follows. It should be noted that the number of stages was 30 to 40 for all.

### EC

Pot temperature: about 150° C., reduced-pressure distillation: 3 to 10 kPa, reflux ratio: 10:1 to 30:1

### EMC

Pot temperature: about 40° C., reduced-pressure distillation: 3 to 10 kPa, reflux ratio: 30:1

### DMC

Pot temperature: about 90 to 110° C., atmospheric distillation: atmospheric pressure, reflux ratio: 1:1

### DEC

Pot temperature: about 80 to 90° C., reduced-pressure distillation: 20 kPa, reflux ratio: 1:1

### PC

Pot temperature: about 130 to 140° C., reduced-pressure distillation: 1 to 5 kPa, reflux ratio: 10:1

### Test Example 1

As the raw solvent, 100 g of EC (main distillate fraction) was weighed in a closed PFA container inside a glovebox at a dew point of −50° C. The above-mentioned PFA container was retrieved from the glovebox, and the reduced-pressure line and gas introduction line were connected to a gas-phase side valve of the container. After setting inside of the container to reduced pressure (−0.09 MPaG), 105 mmol of Lewis acid (phosphorus pentafluoride gas) was introduced thereto. It should be noted that the added amount of the Lewis acid (phosphorus pentafluoride gas) was 11.7% by mass relative to the solvent for an electrolyte liquid (EC (main distillate fraction)). Thereafter, it was immersed in a 50° C. oil bath, and stirring was performed with a stirrer for 15 minutes. Subsequently, upon leaving to stand and 1 hour elapsing, the PFA container was moved inside the glovebox, 13 g of liquid inside of the above-mentioned PFA container was placed in a glass Hazen container, and Hazen measurement (using a color test device (model: OME-2000) manufactured by Nippon Denshoku Industries Co., Ltd.) was performed to make coloring evaluation of the raw solvent. As a result, the Hazen value of the solution after adding Lewis acid (phosphorus pentafluoride gas) was 50. The results are also shown in Table 1.

Using the solvent (EC main distillate fraction) of the same lot as that on which the judgement of hue was performed in the above, an electrolyte liquid was prepared by dissolving LiPF₆ at a concentration of 1.0 mol/L.

### (Electrochemical Characteristic Evaluation of Electrolyte Liquid)

Using the electrolyte liquid prepared by the above- mentioned method, the cell of a lithium ion battery was prepared with LiCoO₂ as the cathode material and graphite as the anode material, and the initial capacitance, cycle characteristic, and internal resistance characteristic of the battery were actually evaluated. A test cell was prepared as follows.

To 90 parts by mass of LiCoO₂ powder, 5 parts by mass of polyvinylidene fluoride (PVDF) as a binder and 5 parts by mass of acetylene black as an electrical conductor were mixed, and N-methylpyrrolidone was further added to make into paste form. This paste was applied onto aluminum foil, and allowed to dry, thereby making a test cathode. In addition, to 90 parts by mass of graphite powder, 10 parts by mass of polyvinylidene fluoride (PVDF) was mixed as a binder, and N-methylpyrrolidone was further added to make into slurry form. This slurry was applied onto copper foil, and allowed to dry for 12 hours at 150° C., thereby making a test anode. Then, a separator made of polyethylene was soaked in the electrolyte liquid and a 50 mAh cell packaged in aluminum laminate was assembled. Using this cell, the cycle characteristic and internal resistance characteristic were evaluated as follows.

### Cycle Characteristic

Using the above-mentioned cell, a charge-discharge test was conducted at a 30° C. environmental temperature, and the cycle characteristic was evaluated. Both charging and discharging were performed at a current density of 0.35 mA/cm². Charging was performed by maintaining the voltage at 4.3 V for 1 hour after the voltage reached 4.3 V. Discharging was performed until the voltage became 3.0 V. Such a charge-discharge cycle was repeated for 500 cycles. Then, the state of degradation of the cell was evaluated with the discharge capacity retention rate after 500 cycles (cycle characteristic evaluation). The discharge capacity retention rate was obtained with the formula below. In the case of the discharge capacity retention rate being at least 80%, the cycle characteristic was evaluated as being favorable, and in the case of the discharge capacity retention rate being less than 80%, the cycle characteristic was evaluated as being inferior. The results are shown in Table 1.

Discharge capacity retention rate after 500 cycles (%)=(discharge capacity after 500 cycles/initial discharge capacity)×100

### Internal Resistance Characteristic (25° C.)

The cell after the cycle test was charged to 4.2 V at a current density of 0.35 mA/cm² at an ambient temperature of 25° C., and then the internal resistance of the battery was measured. The measured internal resistance was converted to a relative value with the initial internal resistance of the cell as 100. In the case of the above-mentioned relative value being no more than 110, the internal resistance characteristic was evaluated as favorable, and in the case of the above-mentioned relative value exceeding 110, the internal resistance characteristic was evaluated as inferior. The results are shown in Table 1.

### (Electrolyte Liquid Coloring Evaluation)

The same electrolyte liquid as that used in the electrochemical characteristic evaluation was prepared, and the Hazen value was measured after storing for 90 days at 45° C. The measurement of Hazen value was performed similarly to as described above. In the case of the measured Hazen value being no more than 100, the electrolyte liquid did not easily become colored, and the coloring resistance was evaluated as favorable, and in the case of the above-mentioned Hazen value exceeding 100, the electrolyte liquid easily colored, and thus the coloring resistance was evaluated as inferior. The results are shown in Table 1.

### Test Example 2

As a result of making coloring evaluation of the raw solvent by performing similar operations to Test Example 1, except for introducing 56.2 mmol of boron trifluoride gas as a Lewis acid, the Hazen value of the solution after adding the Lewis acid (boron trifluoride gas) was 40. It should be noted that the added amount of the Lewis acid (boron trifluoride gas) was 3.7% by mass relative to the solvent for an electrolyte liquid (EC (main distillate fraction)). The results are also shown in Table 1.

Using the solvent (EC main distillate fraction) of the same lot as that on which the judgement of hue was performed in the above, an electrolyte liquid was prepared similarly to Test Example 1, and the electrochemical characteristic evaluation and coloring evaluation of the electrolyte liquid were performed. The results are shown in Table 1.

### Test Example 3

As the raw solvent, 12 g of EC (main distillate fraction) was weighed in a Hazen container made of glass in a glovebox at a dew point of −50° C. To this, 1 g of a complex containing Lewis acid (boron trifluoride diethyl ether complex) was added, and mixing was performed by hand. It should be noted that the added amount of the Lewis acid (boron trifluoride) was 3.5% by mass relative to the solvent for an electrolyte liquid (EC (main distillate fraction)). Next, the container was retrieved from inside the glovebox, and was left to stand maintaining temperature in a constant-temperature bath at 55° C. Coloring evaluation of the raw solvent was made by performing Hazen measurement (using a color test device (model: OME-2000) manufactured by Nippon Denshoku Industries Co., Ltd.) after maintaining temperature for 1 hour. As a result, the Hazen value of the solution after adding a complex containing Lewis acid (boron trifluoride diethyl ether complex) was 40. The results are also shown in Table 1.

Using solvent (EC main distillate fraction) of the same lot as that on which the judgement of hue was performed above, an electrolyte liquid was prepared similarly to Test Example 1, and the electrochemical characteristic evaluation and coloring evaluation of the electrolyte liquid were performed. The results are shown in Table 1.

### Test Examples 4 to 6

Except for using EMC (main distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 7 to 9

Except for using DMC (main distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 10 to 12

Except for using DEC (main distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 13 to 15

Except for using PC (main distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 16 to 19

The judgement of hue was performed by similar operations as Test Example 3 using EC (main distillate fraction) of a different lot, an electrolyte liquid was prepared, and the electrochemical characteristic evaluation and coloring evaluation of the electrolyte liquid were performed. The results are shown in Table 1.

### Test Examples 20 to 22

Except for using EC (initial distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 23 to 25

Except for using EMC (initial distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 26 to 28

Except for using DMC (initial distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 29 to 31

Except for using DEC (initial distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

### Test Examples 32 to 34

Except for using PC (initial distillate fraction) as the raw solvent, the judgement of hue was performed by similar operations as Test Examples 1 to 3, respectively, an electrolyte liquid was prepared, and the electrochemical characteristic evaluation and coloring evaluation of the electrolyte liquid were performed. The results are shown in Table 1.

TABLE 1

| | | | | Discharge | | |
|---|---|---|---|---|---|---|
| | | | | capacity | | Electrolyte |
| | | | Raw solvent | retention | | liquid |
| | | | coloring | rate after | | coloring |
| | | | evaluation | 500 cycles* | Internal | evaluation |
| | Raw solvent | Threshold | (Hazen value) | (%) | resistance* | (Hazen value) |
| Test Example 1 | EC | 200 | 50 | 87 | 103 | 22 |
| | (Main distillate) | | | | | |
| Test Example 2 | EC | 200 | 40 | 88 | 101 | 17 |
| | (Main distillate) | | | | | |
| Test Example 3 | EC | 200 | 40 | 88 | 101 | 18 |
| | (Main distillate) | | | | | |
| Test Example 4 | EMC | 60 | 20 | 90 | 101 | 10 |
| | (Main distillate) | | | | | |
| Test Example 5 | EMC | 60 | 20 | 91 | 101 | 10 |
| | (Main distillate) | | | | | |
| Test Example 6 | EMC | 60 | 15 | 90 | 101 | 8 |
| | (Main distillate) | | | | | |
| Test Example 7 | DMC | 80 | 25 | 90 | 101 | 11 |
| | (Main distillate) | | | | | |
| Test Example 8 | DMC | 80 | 25 | 89 | 101 | 11 |
| | (Main distillate) | | | | | |
| Test Example 9 | DMC | 80 | 25 | 89 | 101 | 11 |
| | (Main distillate) | | | | | |
| Test Example 10 | DEC | 60 | 30 | 88 | 102 | 13 |
| | (Main distillate) | | | | | |
| Test Example 11 | DEC | 60 | 25 | 88 | 101 | 11 |
| | (Main distillate) | | | | | |
| Test Example 12 | DEC | 60 | 25 | 89 | 101 | 11 |
| | (Main distillate) | | | | | |
| Test Example 13 | PC | 160 | 55 | 87 | 102 | 24 |
| | (Main distillate) | | | | | |
| Test Example 14 | PC | 160 | 50 | 86 | 103 | 22 |
| | (Main distillate) | | | | | |
| Test Example 15 | PC | 160 | 45 | 88 | 102 | 20 |
| | (Main distillate) | | | | | |
| Test Example 16 | EC | 200 | 101 | 84 | 104 | 49 |
| | (Main distillate) | | | | | |
| Test Example 17 | EC | 200 | 110 | 83 | 104 | 53 |
| | (Main distillate) | | | | | |
| Test Example 18 | EC | 200 | 190 | 80 | 106 | 78 |
| | (Main distillate) | | | | | |
| Test Example 19 | EC | 200 | 180 | 81 | 105 | 77 |
| | (Main distillate) | | | | | |
| Test Example 20 | EC | 200 | 490 | 48 | 115 | 210 |
| | (Initial distillate) | | | | | |
| Test Example 21 | EC | 200 | 470 | 50 | 113 | 204 |
| | (Initial distillate) | | | | | |
| Test Example 22 | EC | 200 | 480 | 50 | 113 | 208 |
| | (Initial distillate) | | | | | |
| Test Example 23 | EMC | 60 | 350 | 55 | 110 | 152 |
| | (Initial distillate) | | | | | |
| Test Example 24 | EMC | 60 | 350 | 53 | 111 | 154 |
| | (Initial distillate) | | | | | |
| Test Example 25 | EMC | 60 | 345 | 55 | 109 | 154 |
| | (Initial distillate) | | | | | |
| Test Example 26 | DMC | 80 | 340 | 53 | 112 | 152 |
| | (Initial distillate) | | | | | |
| Test Example 27 | DMC | 80 | 335 | 50 | 111 | 145 |
| | (Initial distillate) | | | | | |
| Test Example 28 | DMC | 80 | 330 | 55 | 112 | 145 |
| | (Initial distillate) | | | | | |
| Test Example 29 | DEC | 60 | 335 | 56 | 114 | 145 |
| | (Initial distillate) | | | | | |
| Test Example 30 | DEC | 60 | 335 | 57 | 115 | 145 |
| | (Initial distillate) | | | | | |
| Test Example 31 | DEC | 60 | 330 | 55 | 112 | 145 |
| | (Initial distillate) | | | | | |
| Test Example 32 | PC | 160 | 420 | 50 | 115 | 182 |
| | (Initial distillate) | | | | | |
| Test Example 33 | PC | 160 | 425 | 51 | 115 | 178 |
| | (Initial distillate) | | | | | |
| Test Example 34 | PC | 160 | 420 | 50 | 116 | 180 |
| | (Initial distillate) | | | | | |

*Relative value with initial performance of cell prepared in each Test Example as 100

As shown in Table 1, with Test Examples 1 to 19, for which the Hazen value in the coloring evaluation of raw solvent was no more than the threshold, the decline in cycle characteristic, increase in internal resistance, and coloring of the obtained electrolyte liquid were extremely small, and thus it was confirmed that the amount of the impurities in the raw solvent was not at a level adversely affecting battery performance.

On the other hand, with Test Examples 20 to 34, for which the Hazen value exceeded the threshold in the coloring evaluation of the raw solvent, the decline in cycle characteristic, increase in internal resistance and coloring of the obtained electrolyte liquid were great, and thus it was confirmed that the amount of the impurities in the raw solvent was at a level adversely affecting battery performance.

What is claimed is:

1. A method for judging the amount of impurities in a solvent for an electrolyte liquid to be used in a non-aqueous electrolyte liquid battery, the method comprising:
a reacting step of obtaining a reaction solution by adding a Lewis acid to the solvent for an electrolyte liquid;
a Hazen value measuring step of measuring the Hazen value of the reaction solution; and
a judging step of judging whether the Hazen value is no more than a predetermined threshold.

2. The method for judging according to claim 1, wherein the solvent for an electrolyte liquid is at least one selected from the group consisting of ethylene carbonate, ethylmethyl carbonate, diethyl carbonate, dimethyl carbonate and propylene carbonate; and
the threshold is represented by the formula below:
200×a+60×b+60×c+80×d+160×e,
wherein a is the volume fraction of ethylene carbonate, b is the volume fraction of ethylmethyl carbonate, c is the volume fraction of diethyl carbonate, d is the volume fraction of dimethyl carbonate, and e is the volume fraction of propylene carbonate.

3. The method for judging according to claim 1, wherein, in the reacting step, the addition of the Lewis acid to the solvent for an electrolyte liquid is performed by adding at least one selected from the group consisting of PF₅, BF₃ and a diethyl ether complex of BF₃ to the solvent for an electrolyte liquid.

4. The method for judging according to claim 1, wherein the added amount of the Lewis acid is 1 to 20% by mass relative to the solvent for an electrolyte liquid.

5. A method for producing an electrolyte liquid, comprising a mixing step of mixing, with an electrolytic salt, the solvent for an electrolyte liquid for which the Hazen value has been judged to be no more than the threshold by the method for judging according to claim 1.

6. The method for producing an electrolyte liquid according to claim 5, wherein the electrolytic salt includes at least one selected from the group consisting of LiPF₆, LiBF₄, LiN(SO₂CF₃)₂ and LiN(SO₂C₂F₅)₂.

7. An electrolyte liquid comprising: the solvent for an electrolyte liquid for which the Hazen value has been judged to be no more than the threshold by the method for judging according to claim 1; and an electrolytic salt.

8. The electrolyte liquid according to claim 7, wherein the electrolytic salt includes at least one selected from the group consisting of LiPF₆, LiBF₄, LiN(SO₂CF₃)₂ and LiN(SO₂C₂F₅)₂.
